(19) United States
(12) Patent Application Publication
(10) Pub. No.: US 2013/0266492 A1
(43) Pub. Date: Oct. 10, 2013

(54) TURRET COMPONENT FOR A REAGENT VESSEL

(71) Applicant: ROBERT BOSCH GMBH, Stuttgart (DE)

(72) Inventors: Martina Daub, Weissach (DE); Arne Kloke, Freiburg (DE); Juergen Steigert, Stuttgart (DE); Felix von Stetten, Freiburg-Tiengen (DE); Nils Paust, Freiburg (DE)

(73) Assignee: Robert Bosch GmbH, Stuttgart (DE)

(21) Appl. No.: 13/852,880

(22) Filed: Mar. 28, 2013

(30) Foreign Application Priority Data
Apr. 4, 2012 (DE) 10 2012 205 516.9

(51) Int. Cl. B01L 9/00

(52) U.S. Cl. CPC B01L 9/00
USPC 422/548; 422/547; 494/37; 141/11

(57) ABSTRACT

A turret component for a reagent vessel includes at least one vessel structure into which at least one liquid and/or pulverized material is pourable. The at least one vessel is formed on the turret component, and the turret component has at least one predetermined breaking point on at least one vessel base of the at least one vessel structure. A reagent vessel insertion part for a reagent vessel for a centrifuge and/or for a pressure varying apparatus includes the turret component and also includes an insertion part housing configured to enable insertion of the reagent vessel insertion part into a reagent vessel for a centrifuge and/or a pressure varying apparatus.

This application claims priority under 35 U.S.C. §119 to patent application no. DE 10 2012 205 516.9, filed on Apr. 4, 2012 in Germany, the disclosure of which is incorporated herein by reference in its entirety.

### BACKGROUND

The disclosure relates to a turret component for a reagent vessel. The disclosure also relates to a reagent vessel insertion part and to a reagent vessel. Furthermore, the disclosure relates to a method for centrifuging a material and to a method for the pressure treatment of a material.

DE 10 2010 003 223 A1 describes an apparatus for insertion into a rotor of a centrifuge. The apparatus which is of the size of a standard centrifuge tube can comprise different turrets which are arranged axially one above another. The turrets can have ducts, cavities, reaction chambers and further structures for carrying out standardized fluidic operations. Via an integrated ballpoint pen mechanism, the turrets can be rotated with regard to the positions thereof with respect to one another, as a result of which the structures of the turrets can be indexed with respect to one another. After insertion of the apparatus into a centrifuge, an updating of the ballpoint pen mechanism can be triggered by means of a centrifugal force brought about by the operation of the centrifuge. At the same time, liquids can be transferred along the force vector of the centrifugal force which has been brought about.

### SUMMARY

The disclosure provides a turret component for a reagent vessel with the features described below, a reagent vessel insertion part with the features described below, a reagent vessel with the features described below, a method for centrifuging a material with the features described below and a method for the pressure treatment of a material with the features described below.

The turret component which is realizable by means of the present disclosure and is intended for a reagent vessel is emptiable in a simple manner owing to the at least one predetermined breaking point formed on the vessel base of the at least one vessel structure. An outlet opening through which the at least one liquid and/or pulverized material poured into the vessel structure can emerge is provided just by breaking of the at least one predetermined breaking point. Owing to the at least one outlet opening which is fixedly advanceable by means of the formation of the at least one predetermined breaking point, a material flowing or dropping out of the at least one vessel structure can simply be caught by means of at least one further vessel structure, for example a further turret component.

Unlike a conventional sucking off of the at least one material poured into the at least one vessel structure, the present disclosure therefore provides simpler removal of said material. The at least one predetermined breaking point of the turret component according to the disclosure is also advantageous in relation to the customarily frequently used covering of the at least one base surface of the at least one vessel structure by means of a film, since, with a predetermined breaking point of this type, leakage of the at least one material poured into the at least one vessel structure should more seldom be of concern. By contrast, non-tight points through which the at least one poured-in material can undesirably emerge frequently occur in a covering film.

Furthermore, it is pointed out that, in the production of the turret component according to the disclosure, a capacity/vessel structure does not have to be closed by means of a film, such as, for example, a sealing film made of aluminum. Therefore, the process step which is conventionally frequently required for covering continuous cavities in a turret component by means of a film during the production of the turret component according to the disclosure can be spared. Similarly, the conventionally frequently required formation of a spike structure on a cover of a downstream turret, which is frequently required according to the prior art in order to pierce the film, is also omitted. Also the formation, which is sometimes conventionally carried out, of a double base in a turret according to the prior art, said base being covered with the film, can be omitted in the production of the turret component according to the disclosure. The turret component according to the disclosure is therefore producible with simplified geometry, since a double base is not required, in particular for implementing a switching logic.

The turret component is preferably produced as a single piece by means of a casting method or an injection molding method. The turret component according to the disclosure can therefore be produced cost-effectively by means of a method which can be carried out in a simple manner.

In an advantageous embodiment, the at least one predetermined breaking point partially frames at least one cover element in such a manner that, after breaking of the associated predetermined breaking point, the respective cover element is bendable out of a plane of the associated predetermined breaking point about a predetermined bending point. A sufficiently sized outlet opening suitable for the emergence of the at least one material poured in the at least one vessel structure is thereby reliably realizable. In addition, by means of the formation of the at least one predetermined bending point, it is possible to prevent the breaking of the predetermined breaking point from leading a turret component material which previously covered the outlet opening from dropping into a further vessel structure catching the emerging material.

In a further advantageous embodiment, the turret component has a turret outer wall which is configured in such a manner that the turret component is insertable in a reagent vessel for a centrifuge and/or for a pressure varying apparatus. As an alternative or in addition thereto, the turret component can also be insertable in an insertion part housing of a reagent vessel insertion part, which is configured in such a manner that the reagent vessel insertion part is insertable into a reagent vessel for a centrifuge and/or for a pressure varying apparatus. The turret component according to the disclosure can therefore be used for controlling a chemical reaction and/or a biochemical/molecular biological process while a material is being centrifuged, a positive pressure is being applied and/or a negative pressure is being applied. The turret component according to the disclosure is therefore suitable for a multiplicity of use possibilities.

For example, the at least one predetermined breaking point can be configured in such a manner that the predetermined breaking point is breakable by means of a centrifugal force which can be brought about during operation of the centrifuge, in the rotor device of which the reagent vessel with the turret component inserted therein is arranged, and/or by means of a compressive force which can be brought about during operation of the pressure varying apparatus, in which the reagent vessel with the turret component inserted therein is arranged. In particular, a preferred breaking force can be reliably defined in a simple manner by the formation of the predetermined breaking point. In this case, the at least one predetermined breaking point can be broken simply by bringing about a centrifugal force/or a compressive force equal to the defined breaking force. Therefore, during the operation of the centrifuge and/or of the pressure varying apparatus, an advantageous/preferred time for breaking the at least one predetermined breaking point can be set in a simple manner by correspondingly specifying the speed, the negative pressure and/or the positive pressure.

Furthermore, the turret component can have at least one holding device on and/or in the at least one vessel structure, by means of which at least one mass part is holdable on and/or in the at least one holding device by a retaining force, wherein the at least one holding device is arranged with respect to the at least one predetermined breaking point in such a manner that, after neutralization of the retaining force, the at least one freed mass part drops onto the at least one predetermined breaking point and/or onto at least one base surface which is at least partially framed by the at least one predetermined breaking point. The neutralizing of the retaining force can be reliably implemented, for example, by means of a centrifugal force brought about during the operation of the centrifuge and/or by means of a compressive force brought about during the operation of the pressure varying apparatus. Also in this embodiment, a desired/advantageous time for the emergence of the material poured in the at least one vessel structure can therefore be fixedly kept to by means of specifying the rotational speed, the negative pressure and/or the positive pressure.

The advantages enumerated in the preceding paragraphs are also realizable by means of a reagent vessel insertion part with an insertion part housing which is configured in such a manner that the reagent vessel insertion part is insertable in a reagent vessel for a centrifuge and/or for a pressure varying apparatus, and by at least one turret component, which is arranged in the insertion part housing, according to the disclosure.

In an advantageous embodiment, the reagent vessel insertion part comprises, in addition to a first turret component with the at least one predetermined breaking point, also at least one second turret component, wherein the first turret component and the second turret component are arranged with respect to each other by means of an elastic spacer component in such a manner that the first turret component and the second turret component are bringable into contact with each other by means of a centrifugal force which can be brought about during operation of the centrifuge, in the rotor device of which the reagent vessel with the reagent vessel insertion part inserted therein is arranged, and/or by means of a compressive force which can be brought about during operation of the pressure varying apparatus, in which the reagent vessel with the reagent vessel insertion part therein is arranged, in such a manner that a breaking force is transmittable to the at least one predetermined breaking point via the contact. It can therefore be ensured in a simple manner that, upon breaking of the at least one predetermined breaking point, the second turret component is already in a position in relation to the first turret component, in which position reliable catching of the material emerging from the first turret component by means of the second turret component is ensured.

For example, the reagent vessel insertion part can comprise a ballpoint pen mechanism as the elastic spacer component. A cost-effective mechanism can therefore be used for the elastic spacer component.

The advantages described above are also ensured in a reagent vessel with at least one turret component, which is arranged in the reagent vessel, according to the present disclosure.

In addition, the described advantages are realizable by carrying out the corresponding method for centrifuging a material and the corresponding method for the pressure treatment of a material.

### BRIEF DESCRIPTION OF THE DRAWINGS

Further features and advantages of the present disclosure are explained below with reference to the figures, in which:

FIGS. 1a and 1b show a top view and a cross section of an embodiment of the turret component;

FIGS. 2a and 2b show a cross section and a partial cross section of a first embodiment of a reagent vessel insertion part;

FIG. 3 shows a schematic partial illustration of a second embodiment of a reagent vessel insertion part;

FIG. 4 shows a schematic partial illustration of a third embodiment of the reagent vessel insertion part;

FIG. 5 shows a schematic partial illustration of a fourth embodiment of the reagent vessel insertion part;

FIG. 6 shows a schematic partial illustration of a fifth embodiment of the reagent vessel insertion part; and

FIGS. 7a to 7d show schematic partial illustrations of a sixth embodiment of the reagent vessel insertion part.

### DETAILED DESCRIPTION

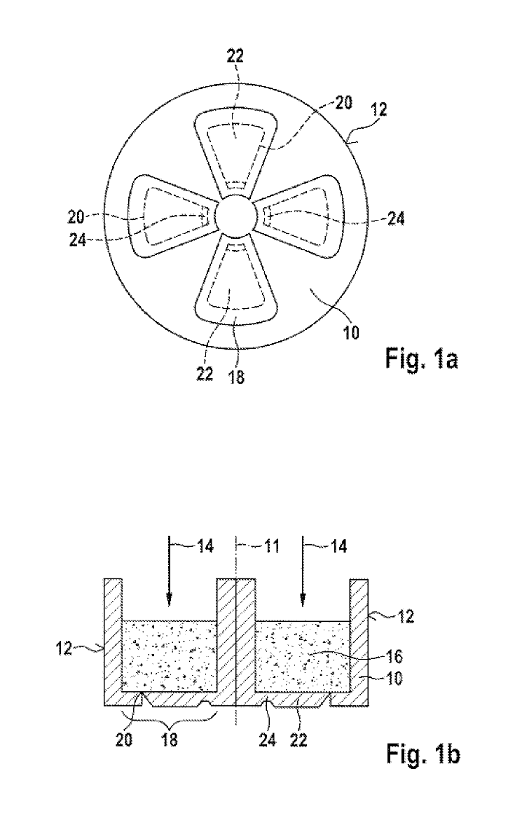

FIGS. 1a and 1b show a top view and a cross section of an embodiment of the turret component.

The turret component 10 which is illustrated schematically in FIGS. 1a and 1b is usable in a reagent vessel. For example, the turret component 10 can have a turret outer wall 12 which is configured in such a manner that the turret component 10 is insertable in a reagent vessel for a centrifuge and/or for a pressure varying apparatus. As an alternative or an addition thereto, the turret component 10 can be insertable owing to the turret outer wall 12 thereof in an insertion part housing of a reagent vessel insertion part, which is configured in such a manner that the reagent vessel insertion part is insertable in a reagent vessel for a centrifuge and/or for a pressure varying apparatus. The insertability of the turret component 10/of the reagent vessel insertion part into the relevant reagent vessel for a centrifuge and/or a pressure varying apparatus can be interpreted to the effect that the turret outer wall 12/an outer wall of the insertion part housing corresponds to an inner wall of the reagent vessel. The turret outer wall 12/the outer wall of the insertion part housing preferably makes contact with the inner wall of the reagent vessel in such a manner that a reliable support of the turret component 10/of the reagent vessel insertion part in the relevant reagent vessel is ensured even during operation of the centrifuge and/or of the pressure varying apparatus.

The reagent vessel can be understood as meaning, for example, a (standard) test glass/test tube. Further exemplary embodiments include centrifuge tubes, 1.5 ml Eppendorf tubes, 2 ml Eppendorf tubes, 5 ml Eppendorf tubes and microtiter plates, for example 20 μl microtiter plates (per cavity). The reagent vessel can likewise be a test substrate or a disposable cartridge, which are embodied in the form of a lab-on-a-chip system on a plastic substrate the size of a plastics card. However, it is stressed that the configuration capability of the reagent vessel is not limited to the examples enumerated here. In addition, the dimensions of the reagent vessel are specified merely on the basis of a desired insertability of the reagent vessel in the centrifuge and/or in the pressure varying apparatus. However, the implementability of the technologies furthermore described according to the disclosure does not prescribe any external shape of the reagent vessel. In addition, the reagent vessel can be configured for receiving samples in a quantity which can optionally be selected from a range of a few μl to 1 l.

It is stressed that no specific types of equipment should be understood by the centrifuge and pressure varying apparatus mentioned below. Instead, the technology according to the disclosure is usable by means of any centrifuge by means of which a (minimum) centrifugal force above 20 g is exertable. Similarly, the technology according to the disclosure can be used for any pressure varying apparatus by means of which a negative pressure and/or positive pressure can be applied.

The turret component 10 can be understood in particular as meaning a turret for a reagent vessel. The turret component 10 can be configured, for example, in such a manner that it is rotatable about an axis of rotation 11 by means of a suitable mechanism which can be arranged on the turret component 10 or separately from the turret component 10. The axis of rotation 11 can run in particular centrally through the turret component 10 and/or can be oriented perpendicularly to the at least one vessel base. In particular, the turret component 10/the reagent vessel insertion part can also be configured for interaction with a ballpoint pen mechanism or can comprise a ballpoint pen mechanism. The turret component 10/the reagent vessel insertion part can hold a volume of smaller than 5 milliliters. The turret component 10 can thus be configured in particular in such a manner that it is integratable in a stack of further turrets and/or reaction chambers. By means of a ballpoint pen mechanism, turrets, reaction chambers and/or cavities (stacked axially one above another) can be positioned axially and also azimuthally with respect to one another. With regard to a possible embodiment of the ballpoint pen mechanism, reference is made to DE 2010 003 223 A1.

At least one vessel structure 14 into which at least one liquid and/or pulverized material 16 is pourable is formed on the turret component 10. In addition, the turret component 10 has at least one predetermined breaking point 20 on at least one vessel base 18 of the at least one vessel structure 14. By means of breaking of the at least one predetermined breaking point 20, at least one outlet opening can therefore be provided, through which the material 16 poured into the at least one vessel structure 14 can flow/drop out. The material 16 poured into the at least one vessel structure 14 can therefore be removed in a simple manner. As is explained more precisely below, a desired/advantageous time for the emergence of the material 16 can also be set by forming the at least one predetermined breaking point 20 for a compressive force which is to be applied for breaking of the latter.

In an advantageous embodiment, at least one predetermined breaking point 20 partially frames at least one cover element 22 in such a manner that, after breaking of the associated predetermined breaking point 20, the respective cover element 22 is bendable out of a plane of the associated predetermined breaking point 20 about a predetermined bending point 24. It is thus possible to prevent the material of the turret component 10 that has previously covered the outlet opening from dropping into a further vessel structure used for catching the emerging material 16. Instead of the at least one predetermined bending point 24, a hinge component and/or a suspending means may also be used.

The at least one predetermined breaking point 20 can be configured in particular in such a manner that the at least one predetermined breaking point 20 is breakable by means of a centrifugal force which can be brought about during operation of the centrifuge, in the rotor device of which the reagent vessel with the turret component 10 inserted therein is arranged, and/or by means of a compressive force which can be brought about during operation of the pressure varying apparatus, in which the reagent vessel with the turret component 10 inserted therein is arranged. The preferred time for the breaking of the at least one predetermined breaking point 20 can therefore be reliably set by means of a corresponding bringing about of the centrifugal force and/or of the compressive force. The at least one predetermined breaking point 20 can be configured, for example, in such a manner that the at least one predetermined breaking point 20 breaks because of a centrifugal force which is exerted by the material 16 stored in the vessel structure 14. This is the case if the centrifugal force above a threshold value, which is typically greater than 20 g, exceeds the mechanical stability of the predetermined breaking point 20. By means of different configurations of the threshold value of the respective predetermined breaking point 20 and/or different masses/tightness of the materials 16, the at least one predetermined breaking point 20 can be broken at a settable/definable time. As is explained even more precisely below, the at least one predetermined breaking point 20 can, however, be broken open at a desired time even without direct breaking of the at least one predetermined breaking point 20 by means of the centrifugal force and/or the compressive force.

The turret component 10, despite the advantageous insertability thereof, can be produced as a single piece by means of a casting method or an injection molding method. The turret component 10 is therefore producible cost-effectively. The internal volume of the turret component 10/of the reagent vessel insertion part can at least partially be made from a polymer, for example from COP, COC, PC, PA, PU, PP, PET and/or PMMA. Further materials are also suitable for forming the internal volume of the turret component 10/of the reagent vessel insertion part.

In addition, at least one duct, at least one cavity and/or at least one reaction chamber can also be formed in the turret component 10/a reagent vessel insertion part equipped therewith. Process steps and structures, such as, for example, sedimentation structures, duct structures or siphon structures for further conducting and switching at least one liquid contained in the turret component 10/the reagent vessel insertion part, can be integrated in the internal volume of the turret component 10/of the reagent vessel insertion part. In particular, at least one further subunit of the internal volume of the turret component 10/of the reagent vessel insertion part as a “storage container” can be filled with at least one liquid which carries out at least one chemical reaction and/or a biochemical/molecular biological process with a material/sample material which is subsequently poured in and is to be processed and/or investigated. The at least one “storage container” can be filled, for example, with chemicals (for example buffers), enzymes, lyophilizates, beads, dyestuffs, antibodies, antigens, receptors, proteins, DNA strands and/or RNA strands. The turret component 10/the reagent vessel insertion part can also be equipped with additional components, such, for example, valves and/or pumps. In addition, the technology according to the disclosure can also interact with a multiplicity of conventional actuation, detection and/or control units.

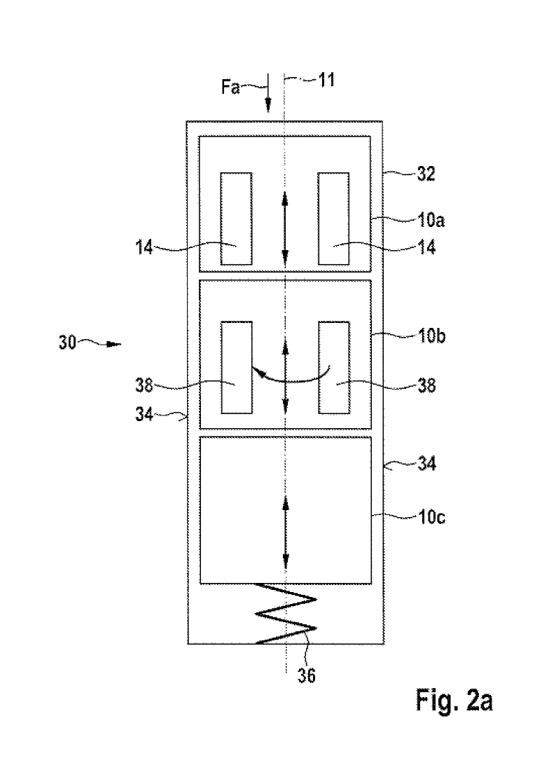

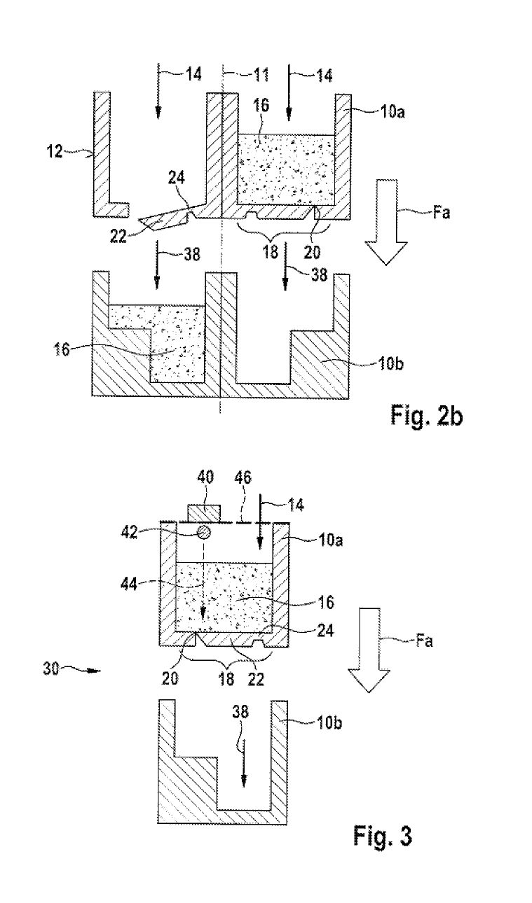

FIGS. 2a and 2b show a cross section and a partial cross section of a first embodiment of a reagent vessel insertion part.

The reagent vessel insertion part 30 which is illustrated schematically in FIGS. 2a and 2b has an insertion part housing 32 which is configured in such a manner that the reagent vessel insertion part 30 is insertable into a reagent vessel for a centrifuge and/or for a pressure varying apparatus. The insertability of the reagent vessel insertion part 32 into the relevant reagent vessel for a centrifuge and/or a pressure varying apparatus can be interpreted to the effect that an outer wall 34 of the insertion part housing 32 corresponds to an inner wall of the reagent vessel. The outer wall 34 of the insertion part housing 32 is preferably in contact with the inner wall of the reagent vessel in such a manner that a reliable support of the reagent vessel insertion part 30 in the relevant reagent vessel is ensured even during operation of the centrifuge and/or of the pressure varying apparatus. With regard to the reagent vessel into which the reagent vessel insertion part 30 is insertable, reference is made to the exemplary embodiments enumerated above. However, the reagent vessel interacting with the reagent vessel insertion part 30 is not limited to said exemplary embodiments.

In addition, the reagent vessel insertion part 30 comprises at least one turret component 10a, 10b and 10c arranged in the insertion part housing 32. The at least one turret component 10a, 10b and 10c can be configured in such a manner that it is rotatable about the axis of rotation 11. In addition, the at least one turret component 10a, 10b and 10c can also be adjustable (laterally) along the axis of rotation 11. As is explained more precisely below, a distance between adjacent turret components 10a, 10b and 10c can also be varied in this manner. With regard to the further fillability of the at least one turret component 10a, 10b and 10c, reference is made to the above descriptions.

The lateral adjustability of the at least one turret component 10a, 10b and 10c can be brought about, for example, by means of a ballpoint pen mechanism 36, which is merely illustrated schematically in FIG. 2a. (Components of the ballpoint pen mechanism can be formed, for example, as part of the first turret component 10a and/or of the second turret component 10b.) Instead of the ballpoint pen mechanism 36, a deformable polymer/elastomer can also be used to provide a resetting force which brings about a return of the at least one turret component 10a, 10b and 10c into a specified starting position. A compressible material, for example a polymer, can likewise be used for this purpose. Instead of a compressible material, use may also be made of an expandable material which produces a tensile force which, as a resetting force, brings about an adjustment back of the at least one turret component 10a, 10b and 10c into a starting position.

In the embodiment illustrated in FIGS. 2a and 2b, the reagent vessel insertion part 30 has, in addition to a first turret component 10a with the at least one predetermined breaking point 20, also at least one second turret component 10b. During operation of a centrifuge and/or of a pressure varying apparatus, a centrifugal force and/or compressive force, as actuation force Fa, can be exerted on the at least one predetermined breaking point 20 in such a manner that the latter breaks. A material 16 poured into the at least one vessel structure 14 of the first turret component 10a can thereby be decanted into a further vessel structure 38 of the second turret component 10b. The second turret component 10b is therefore preferably oriented with regard to the first turret component 10a in the direction of the actuation force Fa. This brings about a reliable decanting of the material 16. In addition, by means of a reduction in the distance between the two turret components 10a and 10b owing to the actuation force Fa, which counteracts the ballpoint pen mechanism 36 or a similar component, a leakage-free transfer of the liquid 16 on the first turret component 10a into the second turret component 10c can be ensured. The reaction vessel insertion part 30 is therefore suitable in particular for swing-out rotors. (The actuation force Fa can also be used for actuating the ballpoint pen mechanism 36 or a similar component.)

FIG. 3 shows a schematic partial illustration of a second embodiment of the reagent vessel insertion part.

The reaction vessel insertion part 30 partially reproduced in FIG. 3 has at least one turret component 10a with at least one predetermined breaking point 20, wherein the turret component 10a has at least one holding device 40 on and/or in the at least one vessel structure 14, by means of which at least one mass part 42 is holdable by a retaining force on and/or in the at least one holding device 40. In addition, the at least one holding device 40 is arranged with respect to the at least one predetermined breaking point 20 in such a manner that, after neutralization of the retaining force, the at least one freed mass part 42 drops onto the at least one predetermined breaking point 20 and/or onto at least one base surface, for example the cover element 22, which is at least partially framed by the at least one predetermined breaking point 20. The at least one mass part 42 therefore acts as an actuation element for breaking the at least one predetermined breaking point 20. The retaining force can be neutralized in particular by means of a centrifugal force and/or a compressive force during operation of a centrifuge and/or of a pressure varying apparatus. The retaining force neutralizing time, which triggers an acceleration of the mass part 42 along a movement path 44 oriented in the direction of the actuation force Fa, can therefore also be advantageously set.

In the embodiment reproduced schematically in FIG. 3, the at least one predetermined breaking point 20 can be configured in such a manner that it does not break and is stable even in the event of a centrifugal acceleration of approximately 10 000 g or in the event of a corresponding compressive force and despite the mass of the material 16 poured in the at least one vessel structure 14. By neutralization of the retaining force of the holding device 40, the mass part 42 can be released and accelerated by means of the actuation force Fa in such a manner that it breaks the predetermined breaking point 20 upon striking on or against the latter. An example of a retaining device 40 which can be used is a magnet, in particular a permanent magnet, which withdraws the mass part 42 which is at least partially formed from a magnetically attractable material. Similarly, the holding device 40 can be a mechanically prestressed holding device 40 into which the mass part 42 is inserted in such a manner that it is released from the mechanically prestressed holding device 40 from a force equal to the retaining force. It is also stressed that the holding device 40 can be an actively controllable actuator which is formable, for example, by means of an actively activatable magnet or a coil. The advantageous position of the at least one holding device 40 can be ensured by attaching the latter to a cover element 46/cover. However, the examples described here for forming and arranging the holding device 40 and the mass part 42 should be interpreted as being merely by way of example.

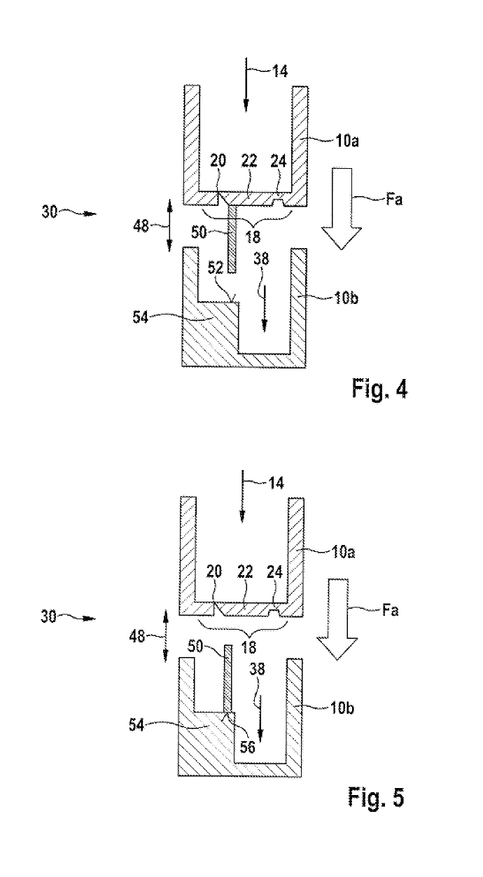

FIG. 4 shows a schematic partial illustration of a third embodiment of the reagent vessel insertion part.

The reagent vessel insertion part 30 partially reproduced schematically in FIG. 4 comprises at least the first turret component 10a with the at least one predetermined breaking point 20, and the second turret component 10b. The first turret component 10a and the second turret component 10b are arranged with respect to each other by means of an elastic spacer component 48 in such a manner that the first turret component 10a and the second turret component 10b are bringable into contact with each other by means of an actuation force Fa, such as, for example, a centrifugal force which can be brought about during operation of a centrifuge, in the rotor device of which the reagent vessel with the reagent vessel insertion part 30 inserted therein is arranged, and/or by means of a compressive force which can be brought about during operation of a pressure varying apparatus, in which the reagent vessel with the reagent vessel insertion part 30 inserted therein is arranged, in such a manner that a breaking force is transmittable to the at least one predetermined breaking point 20 by the contact. The reagent vessel insertion part 30 can comprise, for example, a ballpoint pen mechanism and/or the corresponding components described above as the elastic spacer component 48.

By means of specifying the actuation force Fa, from which the retaining force of the elastic spacer component 48 is neutralized such that there is contact for breaking the predetermined breaking point 20, the time of the breaking of the at least one predetermined breaking point 20 can also be set. The embodiment described here therefore also ensures the advantages mentioned above.

It is stressed in particular that, in the embodiment of FIG. 4, the at least one predetermined breaking point 20 is broken only when there is contact between the two turret components 10a and 10b. It is therefore reliably ensurable that the liquid emerging from the at least one vessel structure 14 of the first turret component 10a is reliably catchable by means of the second turret component 10b.

In the embodiment of FIG. 4, a protrusion 50 is formed on in each case one base region, such as, for example, the cover element 22, which is partially framed by a predetermined breaking point 20. The protrusion 50 preferably extends along the direction of the actuation force Fa, for example radially outward and/or in the direction of the second turret component 10b. The protrusion 50 can be in the form of, for example, an elevation, a web and/or a pin. A reduction in the (lateral) distance between the two turret components 10a and 10b by means of the actuation force Fa leads to contact between the protrusion 50 and the second turret component 10b. The protrusion 50 can come into contact with the second turret component 10b, for example, above a centrifugal acceleration of 20 g. A further increase in the actuation force Fa, for example owing to an increase in the centrifugal acceleration, can result in the respective predetermined breaking point 20 breaking. In particular, after breaking of the associated predetermined breaking point 20 owing to the contact between the protrusion 50 and the second turret component 10b, the cover element 22 can be pressed into the associated vessel structure 14. The material 16 poured into the associated vessel structure 14 is thereby rapidly releasable.

The protrusion 50 preferably makes contact with the second turret component 10b at a contact surface 52 which is located within the further vessel structure 38 of the second turret component 10b. For example, the contact surface 52 can be located on a step 54 formed in the further vessel structure 38 or on a corresponding support structure/protrusion. Instead of the step 54, it is also possible for, for example, a web or a pin to be formed in the further vessel structure 38. It is thereby ensurable that the associated predetermined breaking point 20 breaks only when the outlet opening which is exposed in this manner is advantageously positioned with respect to the further vessel structure 38.

FIG. 5 shows a schematic partial illustration of a fourth embodiment of the reagent vessel insertion part.

In the case of the reagent vessel insertion part 30 partially illustrated in FIG. 5, the protrusion 50 is fastened to a fastening surface 56 of the second turret component 10b. The fastening surface 56 is preferably located within a further vessel structure 38 of the second turret component 10b, for example on a step 54 or on a corresponding support structure/protrusion. (A web or a pin can also be understood by the support structure.) It is therefore also ensured in this case that the desired breaking of the associated predetermined breaking point 20 and/or bending inward of the contacted cover element 22 take/takes place only in an advantageous position of the vessel structures 14 and 38 with respect to each other.

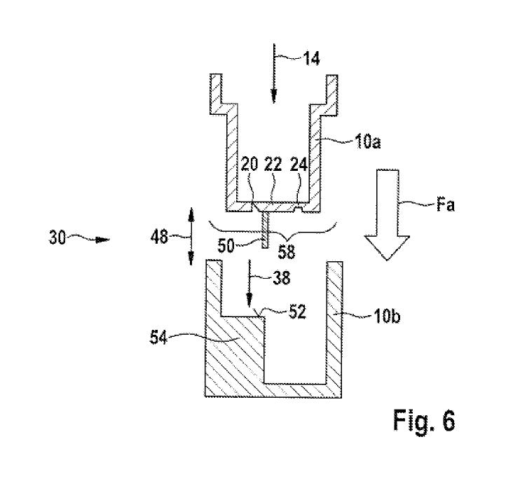

FIG. 6 shows a schematic partial illustration of a fifth embodiment of the reagent vessel insertion part.

In the case of the reagent vessel insertion part 30 partially reproduced schematically in FIG. 6, the geometry of a contact side 58 of the first turret component 10a, which contact side is oriented with respect to the second turret component 10b, is configured in such a manner that the contact side 58 can enter the at least one further vessel structure 38 of the second turret component 10b. In addition, the protrusion 50 which is fastened to the first turret component 10a is of such short configuration that the associated predetermined breaking point 20 breaks only after partial entry of the first turret component 10a into the second turret component 10b. The material 16 poured into the at least one vessel structure 14 can therefore be transferred leakage-free from the at least one vessel structure 14 of the first turret component 10a into at least one further vessel structure 38 of the second turret component 10b. It is stressed that said leakage-free transferring is also ensured if the actuation force Fa is oriented at an inclination with respect to the axis of rotation 11 and/or to a longitudinal axis of the reagent vessel insertion part. This is the case, for example, in the event of processing with a fixed-angle rotor.

The advantageous plug and socket principle of the embodiment of FIG. 6 is formable by the surfaces of the turret components 10a and 10b not only being configured so as to be planar and parallel to each other but also being equipped with elevations and depressions which are arranged in a partially offset, complementary and/or overlapping manner with respect to one another.

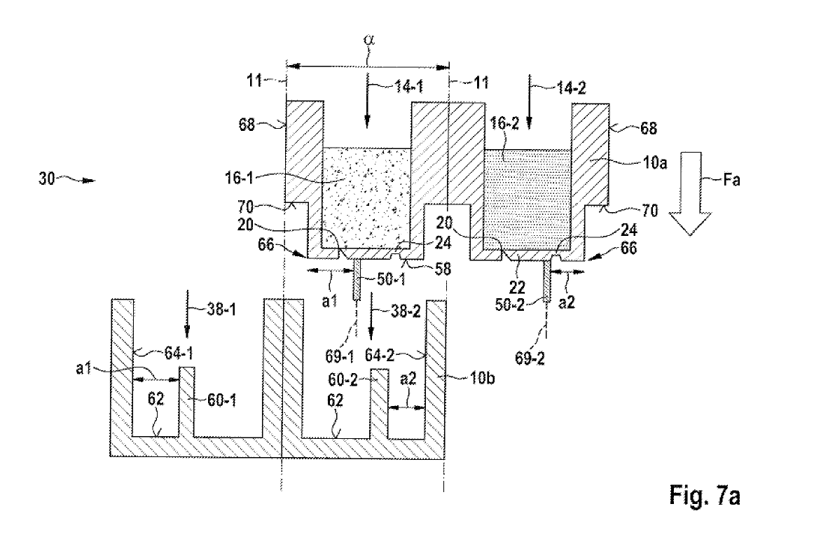

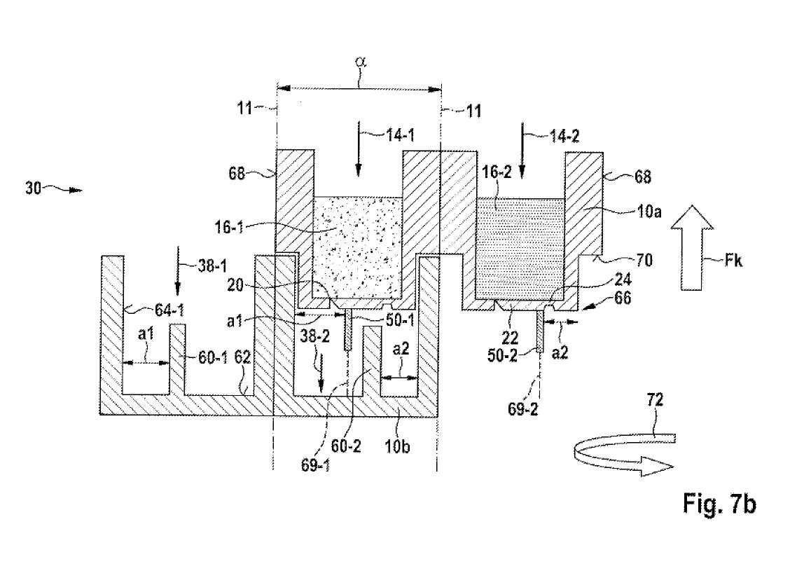

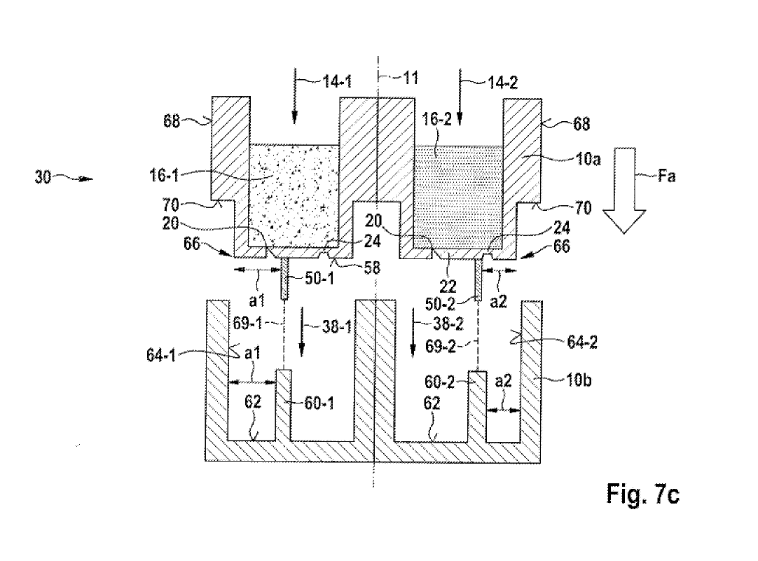

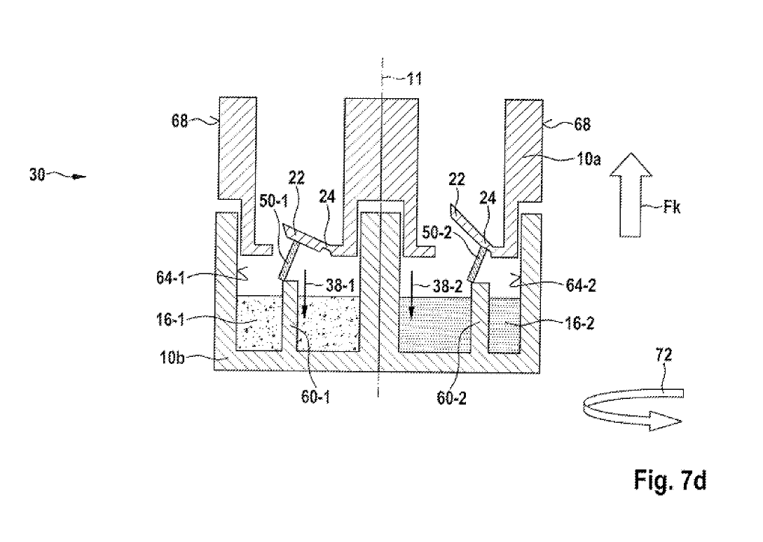

FIGS. 7a to 7d show schematic partial illustrations of a sixth embodiment of the reagent vessel insertion part.

As an addition to the preceding embodiment, the embodiment partially reproduced schematically in FIGS. 7a to 7d has a second turret component 10b, the at least two further vessel structures 38-1 and 38-2 of which respectively have a web element 60-1 and 60-2 protruding from a base surface 62 of the further vessel structure 38. A first web element 60-1 of a first vessel structure 38-1 of the second turret component 10b is arranged at a first distance a1, which is directed away radially from the axis of rotation 11, from a side inner wall 64-1 of the first vessel structure 38-1, which distance deviates from a second distance a2, which is directed away radially from the axis of rotation 11 and at which a second web element 60-2 of a second vessel structure 38-2 of the second turret component 10b is arranged from a side inner wall 64-2 of the second vessel structure 38-2. Side wall surfaces on an outer wall protruding from the base surface 62 can be understood by the side inner walls 64-1 and 64-2, wherein the outer wall can be oriented in particular (virtually) parallel to the axis of rotation 11. (If the second turret component 10b also comprises at least one third vessel structure, the web element thereof can be arranged at a third distance, which is directed away radially from the axis of rotation 11, from a side inner wall of the third vessel structure, which distance is not equal to the distances a1 and a2. The number of different distances can therefore be equal to the number of vessel structures of the second turret component 10b.)

Each of the at least two vessel structures 38-1 and 38-2 of the second turret component 10b is preferably assigned a respective vessel structure 14-1 and 14-2 of the first turret component 10a. The vessel structures 14-1 and 14-2 of the first turret component 10a have respective protrusions 50-1 and 50-2 which are arranged on the contact side 58 at a distance a1 or a2, which is directed away radially from the axis of rotation 11, from an edge 66, which is adjacent to the contact side 58, of a side outer wall 68 of the first turret component 10a. A first protrusion 50-1 of a first vessel structure 14-1 of the first turret component 10a, which protrusion is assigned to the first vessel structure 38-1 of the second turret component 10b, is therefore arranged on the contact side 58 at the first distance a1, which is directed away radially from the axis of rotation 11, from the edge 66 of the side outer wall 68 of the first turret component 10a. Correspondingly, a second protrusion 50-2 of a second vessel structure 14-2 of the first turret component 10a, which protrusion is assigned to the second vessel structure 38-1 of the second turret component 10b, is arranged on the contact side 58 at the second distance a2, which is directed away radially from the axis of rotation 11, from the edge 66 of the side outer wall 68 of the first turret component 10a. This makes it possible to realize a switching logic by means of which a first material 16-1 poured into the first vessel structure 14-1 of the first turret component 10a and a different, second material 16-2 poured into the second vessel structure 14-2 of the first turret component 10a are transferable in a selective/specific manner into certain vessel structures 38-1 and 38-2 of the second turret component 10b.

FIG. 7a shows a rotational position of the two turret components 10a and 10b with respect to each other, in which the vessel structures 14-1 and 14-2 of the first turret component 10a are rotated through an angle of rotation a not equal to zero in relation to the vessel structures 38-1 and 38-2 that are assigned thereto of the second turret component 10b. (The angle of rotation a which is unequal to zero is illustrated as a distance in FIG. 7b for better clarity.) If the retaining force of the elastic spacer component is neutralized by the actuation force Fa at this angle of rotation not equal to zero, although the first turret component 10a partially enters the second turret component 10b, each of the vessel structures 14-1 and 14-2 of the first turret component 10a enters a vessel structure 38-1 and 38-2, that is not assigned thereto, of the second turret component 10b (see FIG. 7b). The first vessel structure 14-1 of the first turret component 10a enters, for example, the second vessel structure 38-1 of the second turret component 10b. Owing to the different distances a1 and a2, the first protrusion 50-1 of the first vessel structure 14-1 of the first turret component 10a does not, however, strike along the entry path 69-1 thereof against the second support structure 60-2 of the second vessel structure 38-2 of the second turret component 10b. (Correspondingly, the second protrusion 50-2 of the second vessel structure 14-2 of the first turret component 10a also does not make contact along the entry path 69-2 thereof with the first support structure 60-1 of the first vessel structure 38-1 of the second turret component 10b.) The difference between the distances a1 and a2 is therefore selected to be of a size sufficient to prevent contact between the first protrusion 50-1 of the first vessel structure 14-1 of the first turret component 10a and the second support structure 60-2 of the second vessel structure 38-1 of the second turret component 10b despite entry of the first vessel structure 14-1 of the first turret component 10a into the second vessel structure 38-1 of the second turret component 10b. In addition, the first turret component 10a on the side outer wall 68 has a diameter expansion which is in the form, for example, of an outer step 70. Perpendicularly to the axis of rotation, the space spanned by the side inner walls 64-1 and 64-2 of the second turret component 10b has a maximum extension which is smaller than the maximum diameter of the side outer wall 68 of the first turret component 10a. A holding structure is therefore formed between the two turret components, the holding structure, even upon further pressing of the two turret components 10a and 10b against each other, preventing deeper entry of the first turret component 10a into the second turret part 10b.

Despite the entry of the first vessel structure 14-1 of the first turret component 10a into the second vessel structure 38-2 of the second turret component 10b, the second turret component 10b therefore does not exert any force on the predetermined breaking points 20 of the first turret component 10a. The two turret components 10a and 10b are subsequently pulled apart again from each other by means of a force Fk of a ballpoint pen mechanism (not outlined). A subsequent rotation 72 of the first turret component 10a relative to the second turret component 10b brings the two turret components 10a and 10b into a position with respect to each other in which the vessel structures 14-1 and 14-2 of the first turret component 10a are oriented with respect to the vessel structures 38-1 and 38-2, which are assigned thereto, of the second turret component 10b (see FIG. 7c). A renewed drawing together of the two turret components 10a and 10b (for example by means of the actuation force Fa) therefore leads to the first vessel structure 14-1 of the first turret component 10a entering the first vessel structure 38-1 of the second turret component 10b and to the second vessel structure 14-2 of the first turret component 10a entering the second vessel structure 38-2 of the second turret component 10b. In the process, the protrusions 50-1 and 50-2 each enter into contact with the support structures 60-1 and 60-2 assigned thereto, and therefore the predetermined breaking points 20 are broken and material outlet openings in the vessel structures 14-1 and 14-2 of the first turret component 10a are opened. The different materials 16-1 and 16-2 can therefore be poured in a specific manner into the vessel structures 38-1 and 38-2, which are allocated thereto, of the second turret component 10b.

In an advantageous development, a vessel structure 38-1 and 38-2 of the second turret component 10b can also have a plurality of support structures 60-1 and 60-2 at different positions. The vessel structures 38-1 and 38-2 of the second turret component 10b can thereby be coupled to a plurality of vessel structures 14-1 and 14-2 of the first turret component 10a. The further vessel structure 38-1 and 38-2 of the second turret component 10b can therefore advantageously be used as a mixing chamber and/or incubation chamber. In addition, a vessel structure 14-1 and 14-2 of the first turret component 10a can also have a plurality of protrusions 50-1 and 50-2 at different positions.

The embodiment described in the above paragraphs may also be combined differently with one another.

In addition, the statements made in the paragraphs above also apply to a reagent vessel insertion part according to the technology of the disclosure for a reagent vessel for a centrifuge and/or a pressure varying apparatus which is configured according to the explained reagent vessel insertion parts. The advantageous reagent vessel has an outer wall which is configured in such a manner that the reagent vessel is insertable in a centrifuge and/or in a pressure varying apparatus. In particular, the reagent vessel is configured in such a manner that a reliable support of the reagent vessel in the centrifuge under operation and/or in the pressure varying apparatus under operation is ensured. A reagent vessel for a centrifuge and/or for a pressure varying apparatus can therefore be understood as meaning a reagent vessel which, owing to the (outer) shape thereof, is readily suitable for operation of the centrifuge at a comparatively great rotational speed and/or for application of a positive pressure and/or negative pressure, which deviates greatly from the atmospheric pressure, by means of the pressure varying apparatus. The advantageous reagent vessel can have vessel structures, such as, for example, ducts, reaction chambers, storage chambers and/or active components, for example valves and/or pumps. In addition, the reaction vessel can comprise actuation, detection and control units. Chemical reactions and/or biochemical/molecular biological processes can therefore proceed in the reagent vessel in a fully automated manner.

The advantageous reagent vessel has at least one turret component which is arranged in the reagent vessel and has at least one predetermined breaking point. Furthermore, the reagent vessel can comprise, in addition to a first turret component with the at least one predetermined breaking point, also at least one second turret component, wherein the first turret component and the second turret component are arranged with respect to each other by means of an elastic spacer component in such a manner that the first turret component and the second turret component are bringable into contact with each other by means of a centrifugal force which can be brought about during operation of a centrifuge, in the rotor device of which the reagent vessel is arranged, and/or by means of a compressive force which can be brought about during operation of a pressure varying apparatus, in which the reagent vessel is arranged, in such a manner that a breaking force is transmittable to the at least one predetermined breaking point by the contact. For example, the reagent vessel can comprise a ballpoint pen mechanism as the elastic spacer component. The other embodiments described above are also applicable to the advantageous reagent vessel.

The advantages enumerated in the above paragraphs are also ensured when carrying out the method for centrifuging a material and the method for the pressure treatment of a material.

What is claimed is:

1. A turret component for a reagent vessel, comprising:
at least one vessel structure formed on the turret component and configured to receive at least one liquid and/or pulverized material; and
at least one predetermined breaking point on at least one vessel base of the at least one vessel structure.

2. The turret component according to claim 1, wherein the turret component is produced as a single piece by one of a casting method and an injection molding method.

3. The turret component according to claim 1, wherein the at least one predetermined breaking point is configured to partially frame at least one cover element such that, after the associated predetermined breaking point breaks, the respective cover element is bendable out of a plane of the associated predetermined breaking point about a predetermined bending point.

4. The turret component according to claim 1, further comprising a turret outer wall configured to enable insertion of the turret component in a reagent vessel for a centrifuge and/or a pressure varying apparatus.

5. The turret component according to claim 1, wherein:
the turret component is configured to enable insertion into an insertion part housing of a reagent vessel insertion part, and
the reagent vessel insertion part is configured to enable insertion into a reagent vessel for a centrifuge and/or a pressure varying apparatus.

6. The turret component according to claim 5, wherein:
the at least one predetermined breaking point is configured to be broken by at least one of:
a centrifugal force brought about during operation of the centrifuge when the reagent vessel with the turret component inserted therein is arranged in a rotor device of the centrifuge, and
a compressive force brought about during operation of the pressure varying apparatus when the reagent vessel with the turret component inserted therein is arranged in the pressure varying apparatus.

7. The turret component according to claim 1, further comprising:
at least one holding device on and/or in the at least one vessel structure, the at least one holding device configured to hold at least one mass part on and/or in the at least one holding device by a retaining force,
wherein the at least one holding device is arranged with respect to the at least one predetermined breaking point such that, after neutralization of the retaining force, the at least one mass part is freed and drops onto at least one of the at least one predetermined breaking point and at least one base surface which is at least partially framed by the at least one predetermined breaking point.

8. A reagent vessel insertion part, comprising:
an insertion part housing configured to enable insertion of the reagent vessel insertion part into a reagent vessel for a centrifuge and/or a pressure varying apparatus; and
at least one turret component arranged in the insertion part housing, the at least one turret component including:
at least one vessel structure formed on the at least one turret component and configured to receive at least one liquid and/or pulverized material; and
at least one predetermined breaking point on at least one vessel base of the at least one vessel structure.

9. The reagent vessel insertion part according to claim 8, wherein:
the at least one turret component includes a first turret component with the at least one predetermined breaking point and at least one second turret component, and
the first turret component and the second turret component are arranged with respect to each other by an elastic spacer component such that the first turret component and the second turret component are brought into contact with each other in such a manner that a breaking force is transmittable to the at least one predetermined breaking point by the contact by at least one of:
a centrifugal force brought about during operation of the centrifuge when the reagent vessel with the reagent vessel insertion part inserted therein is arranged in a rotor device of the centrifuge, and
a compressive force brought about during operation of the pressure varying apparatus when the reagent vessel with the reagent vessel insertion part inserted therein is arranged in the pressure varying apparatus.

10. The reagent vessel insertion part according to claim 9, wherein the elastic spacer component is a ballpoint pen mechanism.

11. A reagent vessel for a centrifuge and/or for a pressure varying apparatus, comprising:
at least one turret component including:
at least one vessel structure formed on the turret component and configured to receive at least one liquid and/or pulverized material;
at least one predetermined breaking point on at least one vessel base of the at least one vessel structure; and
a turret outer wall configured to enable arrangement of the turret component in the reagent vessel.

12. The reagent vessel according to claim 11, wherein:
the at least one turret component includes a first turret component with the at least one predetermined breaking point and at least one second turret component, and
the first turret component and the second turret component are arranged with respect to each other by an elastic spacer component such that the first turret component and the second turret component are brought into contact with each other in such a manner that a breaking force is transmittable to the at least one predetermined breaking point by the contact by at least one of:
a centrifugal force brought about during operation of the centrifuge when the reagent vessel is arranged in a rotor device of the centrifuge, and
a compressive force brought about during operation of the pressure varying apparatus when the reagent vessel is arranged within the pressure varying apparatus.

13. The reagent vessel according to claim 12, wherein the elastic spacer component is a ballpoint pen mechanism.

14. A method for centrifuging a material, comprising:
pouring the material to be centrifuged into the regent vessel as claimed in claim 11; and
at least operating the centrifuge at a rotational speed which brings about a centrifugal force sufficient to break the at least one predetermined breaking point.

15. A method for the pressure treatment of a material, comprising:
pouring the material to be treated into the regent vessel as claimed in claim 11; and
applying, at least once, one of a negative pressure and a positive pressure configured to bring about a compressive force sufficient to break the at least one predetermined breaking point.
